(19) United States
(12) Patent Application Publication
(10) Pub. No.: US 2019/0091850 A1
(43) Pub. Date: Mar. 28, 2019

(54) TOOL GRIP

(71) Applicant: Yu-Hua OU, Taichung City (TW)

(72) Inventor: Yu-Hua OU, Taichung City (TW)

(21) Appl. No.: 15/718,332

(22) Filed: Sep. 28, 2017

(51) Int. Cl. B25G 1/10; B25B 23/16; B25B 23/00

(52) U.S. Cl. CPC B25G 1/102; B25B 15/02; B25B 23/0042; B25B 23/16

(57) ABSTRACT

A tool grip is provided, includes a grip portion, a metal base, and a coating. The metal base is disposed on the grip portion, the metal base includes a hole for receiving a drive rod and a plurality of rib portions extending radially outwardly relative to the hole. Each of the plurality of rib portions includes a bridge section and a grip plate. The bridge section extending radially is connected with the grip plate and located between the hole and the grip plate. The grip plate is greater than the bridge section in circumferential size. The coating covers the metal base. At least part of the coating is disposed in a recess between adjacent two of the rib portions. At least part of each of the grip plate is exposed radially relative to the coating.

### BACKGROUND OF THE INVENTION

### Field of the Invention

The present invention relates to a hand tool, especially relates to a tool grip.

### Description of the Prior Art

Part of a hand tool has a rod body; the rod body has a drive head on the one end. In use, users need to rotate the rod body around its axle to drive a workpiece. The conditional hand tool has an outer layer which coats the rod body so that the users can grip the rod body to tighten the workpiece.

However, the outer layer of the conditional hand tool is usually made of a plastic material in an injection molding. In operating, the force of the workpiece is easily absorbed by the outer layer so as to reduce the transmission of the force, the force includes the driven force and the reaction force. Moreover, the outer layer and the rod body are easily to be separated by the twisting force. And the outer layer of the conditional hand tool only coats the rod body in one layer, so that the outer layer can be easily damaged and reduce the lifetime in long-term effect by the twisting force.

The present invention is, therefore, arisen to obviate or at least mitigate the above mentioned disadvantages.

### SUMMARY OF THE INVENTION

An object of the present invention is to provide a tool grip, in which the tool grip can transmit the force efficiency.

To achieve the above and other objects, a tool grip is provided. The tool grip includes a grip portion, a metal base, and a coating. The metal base is disposed on the grip portion, the metal base includes a hole for receiving a drive rod and a plurality of rib portions extending radially outwardly relative to the hole. Each of the plurality of rib portions includes a bridge section and a grip plate. The bridge section extending radially is connected with the grip plate and located between the hole and the grip plate. The grip plate is greater than the bridge section in circumferential size. The coating covers the metal base. At least part of the coating is disposed in a recess between adjacent two of the rib portions. Wherein at least part of each of the grip plate is exposed radially relative to the coating.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a tool grip according to a preferred embodiment of the present invention;

FIG. 2 is a cross-sectional view of a preferable embodiment of the present invention;

FIG. 3 is a perspective view of a preferable embodiment of the present invention connected with a drive rod; and

FIG. 4 is another cross-sectional view of a preferable embodiment of the present invention.

### DETAILED DESCRIPTION OF THE PREFERRED EMBODIMENTS

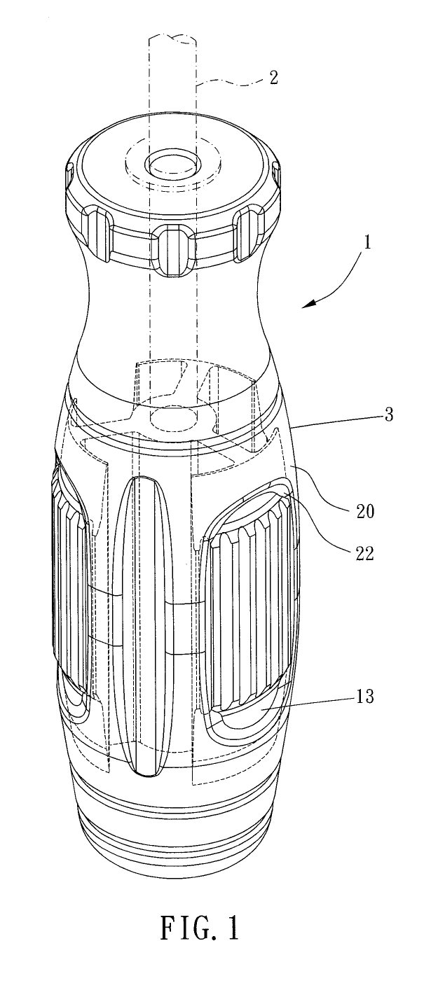

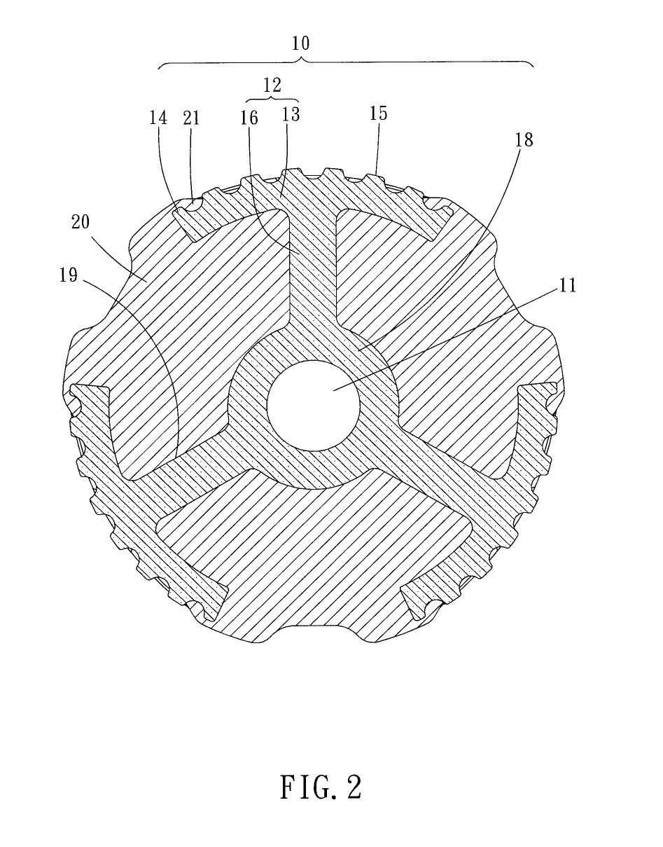

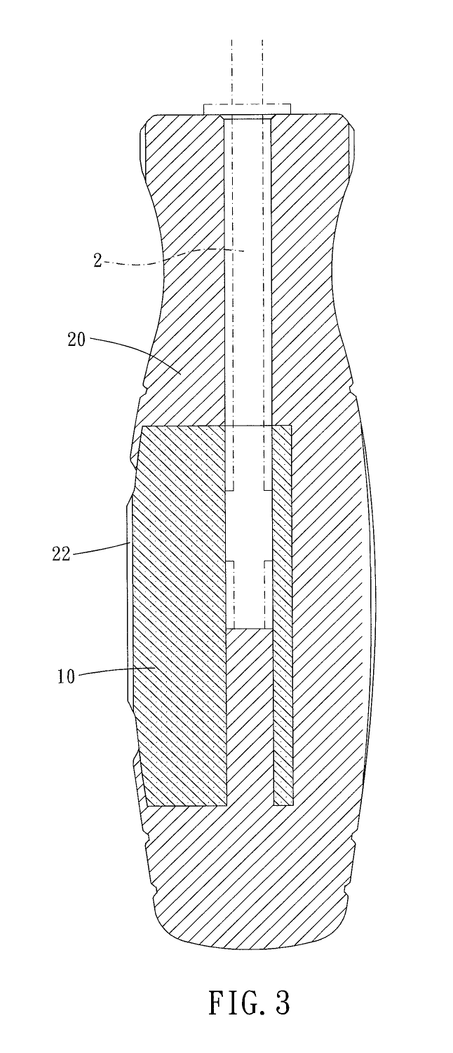

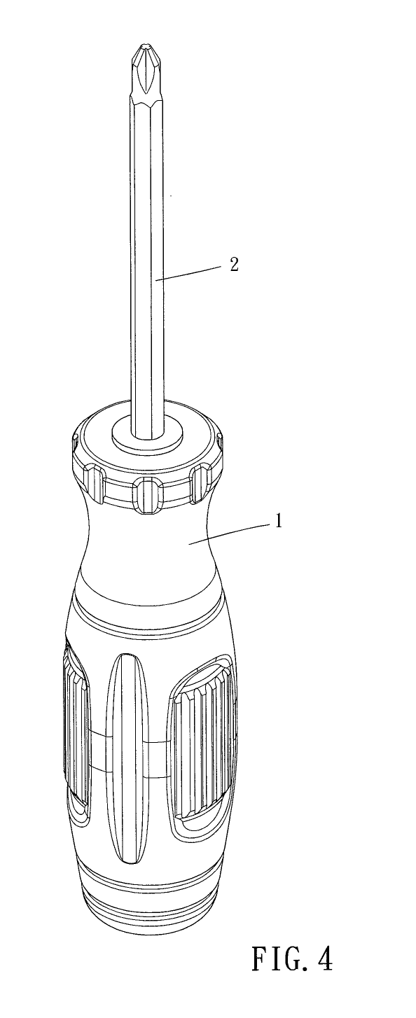

FIGS. 1-4 show a tool grip according to a preferred embodiment of the present invention. The tool grip 1 includes a grip portion 3, a metal base 10, and a coating 20.

The metal base 10 is disposed on the grip portion 3, the metal base 10 includes a hole 11 for receiving a drive rod 2 and a plurality of rib portions 12 extending radially outwardly relative to the hole 11. The drive rod 2 has a drive head such as a torx drive head, a cross-slot drive head, a clutch drive head, a regular head and so on. Also, the drive rod 2 has a wing portion which extends radially and connected with the hole 11 in the radial direction. Each of the plurality of rib portions 12 includes a bridge section 16 and a grip plate 13. The bridge section 16 extending radially is connected with the grip plate 13 and located between the hole 11 and the grip plate 13. The grip plate 13 is greater than the bridge section 16 in circumferential size. The coating 20 covers the metal base 10. At least part of the coating 20 is disposed in a recess 19 between adjacent two of the rib portions 12. Wherein at least part of each of the grip plate 13 is exposed radially relative to the coating 20. Thus, the force can be transmitted efficiently through each of the rib portion 12, and the coating 20 and the metal base 10 can be joined fixedly, and also provide a long using lifetime. In this embodiment, the metal base 10 is made of aluminum alloy, so as to strong structural strength and transmit the force efficiency. In other embodiment, the metal base can be other metal materials. In this embodiment, the coating 20 is made of plastic material, so as to provide a greater comfort to grip. In other embodiment, the coating can be made of thermoplastic rubber composite material, oil-resistant thermoplastic rubber composite material and other elastic materials.

The coating 20 is fixedly attached to the metal base 10 so that the coating 20 and the metal base 10 can be connected securely and do not slide or rotate relative to each other. Preferably, the coating 20 is a flexible coating, the flexible coating and the grip plates 13 of the plurality of rib portions 12 form a common grip face. Thus, when gripping the common grip face in operation, the hand can receive the force transmitted from the common grip face and grip comfortably. In this embodiment, the common grip face is a circumference of the tool grip 1.

The extending size of the bridge section 16 in the axial indirection and the extending size of the grip plates 13 of the plurality of rib portions 12 in the axial size are substantially the same so as to provide a sufficient support force.

The metal base 10 further includes a tubular portion 18 defining the hole 11. The tubular portion 18 can be a closed ring body or non-continuous ring body. The plurality of rib portions 12 are disposed around the peripheral of the tubular portion 18, and the tubular portion 18 and the plurality of rib portions 12 are integrally formed of one piece. Preferably, the tubular portion 18 is less than the grip plates 13 of the plurality of rib portions 12 in curvature.

The plurality of rib portions 12 are equiangulary disposed around the peripheral of the tubular portion 18, thus the force can be distributed equally around the tool grip 1. Besides, the grip plates 13 of the plurality of rib portions 12 are disposed separately.

Preferably, at least part of the grip plate 13 abuts radially against the coating 20, so as to provide the support force. Furthermore, the grip plate 13 includes at least one first hook structure 14, and the coating 20 includes at least one second hook structure 12 which hooks with the at least one first hook structure 14. The number of the at least one first hook structure 14 and at least one second hook structure 12 are plural respectively so as to strong the connection of the grip plate 13 and the coating 20, therefore the grip plate 13 is not liable to remove from the coating 20.

The grip plate 13 is a curve-shaped plate which proturdes radially. In this embodiment, the grip plates 13 of the plurality of rib portion 12 are substantially the same in curvature, so as to provide a greater comfort to grip and good for operation. In other embodiment, the grip plate 13 can be a non-curved face such as a flat, a polygon, etc. In this embodiment, the grip plate 13 includes a concave-convex structure 15, for instance a wave structure, so as to increase the friction of the grip plate 13 for gripping easily. In other embodiment, the grip plate 13 can be a frosting surface, a grid structure and other structures which can increase the friction of the grip plate 13.

A periphery of the coating 20 includes at least one concave 22, the grip plate 13 of the at least one rib portion 12 is disposed in the at least one concave 22. In this embodiment, the number of the at least one concave 22 is plural. Besides, each of the concave 22 extends radially. Therefore, each of the grip plate 13 can be positioned stably, and does not liable to slide relative to the coating 20.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool grip, including:
a grip portion;
a metal base, disposed on the grip portion, the metal base including a hole for receiving a drive rod and a plurality of rib portions extending radially outwardly relative to the hole, each of the plurality of rib portions including a bridge section and a grip plate, the bridge section extending radially connected with the grip plate and located between the hole and the grip plate, the grip plate being greater than the bridge section in circumferential size;
a coating, covering the metal base, at least part of the coating disposed in a recess between adjacent two of the rib portions;
wherein at least part of each of the grip plate is exposed radially relative to the coating.

2. The tool grip of claim 1, wherein the metal base further includes a tubular portion defining the hole, the plurality of rib portions are disposed around a peripheral of the tubular portion, and the tubular portion and the plurality of rib portions are integrally formed of one piece.

3. The tool grip of claim 2, wherein the plurality of rib portions are equiangulary disposed around the peripheral of the tubular portion.

4. The tool grip of claim 1, wherein the coating is fixedly attached to the metal base.

5. The tool grip of claim 1, wherein the coating is a flexible coating, and the flexible coating and the grip plates of the plurality of rib portions form a common grip face.

6. The tool grip of claim 1, wherein at least part of the grip plate abuts radially against the coating.

7. The tool grip of claim 1, wherein the grip plate includes at least one first hook structure, and the coating includes at least one second hook structure which hooks with the at least one first hook structure.

8. The tool grip of claim 1, wherein the grip plates of the plurality of rib portions are disposed separately.

9. The tool grip of claim 1, wherein a periphery of the coating includes at least one concave, and the grip plate of the at least one rib portion is disposed in the at least one concave.

10. The tool grip of claim 2, wherein the metal base is made of aluminum alloy; the coating is a flexible coating, and the flexible coating and the grip plates of the plurality of rib portions form a common grip face; the coating is made of plastic material; the plurality of rib portions are equiangulary disposed around the peripheral of the tubular portion; the grip plates of the plurality of rib portions are disposed separately; the coating is fixedly attached to the metal base; at least part of the grip plate abuts radially against the coating; the grip plate includes at least one first hook structure, and the coating includes at least one second hook structure which hooks with the at least one first hook structure; a periphery of the coating includes at least one concave, and the grip plate of the at least one rib portion is disposed in the at least one concave; the grip plate is a curve-shaped plate which protrudes radially; the grip plates of the plurality of rib portions are substantially the same in curvature; the extending size of the bridge section in the axial indirection and the extending size of the grip plates of the plurality of rib portions in the axial size are substantially the same; the tubular portion is substantially less than the grip plates of the plurality of rib portions in curvature; the grip plate includes a concave-convex structure.
